(19) United States
(12) Patent Application Publication
(10) Pub. No.: US 2023/0034332 A1
(43) Pub. Date: Feb. 2, 2023

(54) IMAGE PROCESSING APPARATUS, METHOD, STORAGE MEDIUM THAT STORES PROGRAM

(71) Applicant: CANON KABUSHIKI KAISHA, Tokyo (JP)

(72) Inventors: Takeru SASAKI, Kanagawa (JP); Hiroyasu Kunieda, Kanagawa (JP); Hideki Kubo, Kanagawa (JP); Yoshitaka Minami, Kanagawa (JP); Kazuya Ogasawara, Kanagawa (JP); Masao Kato, Kanagawa (JP)

(21) Appl. No.: 17/864,585

(22) Filed: Jul. 14, 2022

(30) Foreign Application Priority Data
Jul. 30, 2021 (JP) 2021-126046

(51) Int. Cl. G06T 7/49; G06T 7/11; G06T 11/00; G06F 16/583

(52) U.S. Cl. CPC G06T 7/49; G06F 16/5862; G06T 7/11; G06T 11/001

(57) ABSTRACT

The texture data acquired by the first acquisition unit is processed so as to accord with a size of the region set by the setting unit, and the illumination data acquired by the second acquisition unit is processed so as to accord with the size of the region set by the setting unit. The decoration data is generated from the texture data processed by the first processing unit and the illumination data processed by the second processing unit, and the decoration data is applied to the region set by the setting unit are comprised.

### BACKGROUND OF THE INVENTION

### Field of the Invention

The present invention relates to an image processing apparatus that performs decoration processing, a method, and a storage medium that stores a program.

### Description of the Related Art

Decoration processing in which texture is added to an image by combining texture information, such as metal, cloth, and canvas, into image information is known. Not only texture information but also illumination information indicating brightness distribution may be added, especially when expressing metallic texture. Japanese Patent Laid-Open No. 2009-93287 discloses a technique for representing a more realistic reflectivity of metal by combining into image information texture information reflecting illumination information.

### SUMMARY OF THE INVENTION

The present invention provides an image processing apparatus that realizes appropriate decoration processing that accords with a size of a target region, a method, and a storage medium that stores a program.

The present invention in one aspect provides a method comprising: setting a region in which decoration processing is to be applied on an image according to decoration data; acquiring texture data representing a texture image of a predetermined size; acquiring illumination data representing a brightness contrast of a region of a predetermined size; processing the acquired texture data so as to accord with a size of the set region; processing the acquired illumination data so as to accord with the size of the set region; and generating the decoration data from the processed texture data and the processed illumination data, and applying the decoration data to the set region.

According to the present invention, it is possible to realize appropriate decoration processing that accords with a size of a target region.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of an image processing apparatus.

FIG. 2 is a diagram illustrating a user interface screen.

FIG. 3 is a block diagram illustrating a configuration of a decoration application.

FIGS. 4A to 4C are diagrams illustrating distributions of a skewness of texture.

FIG. 5 is a diagram illustrating a frequency response characteristic of human vision.

FIG. 6 is a flowchart for explaining decoration processing.

FIG. 7 is a flowchart for explaining processing for generating a texture pattern.

FIG. 8 is a flowchart for explaining processing for generating an illumination pattern.

FIG. 9 is a flowchart for explaining printing processing in an output apparatus.

FIG. 10 is a diagram for explaining a comparison between an effect of a conventional technique and an effect of a first embodiment.

FIG. 11 is a diagram for explaining a comparison between an effect of a conventional technique and an effect of the first embodiment.

FIG. 12 is a diagram for explaining a comparison between an effect of a conventional technique and an effect of the first embodiment.

FIGS. 13A and 13B are diagrams illustrating illumination data.

FIG. 14 is a diagram illustrating a table for specifying illumination data.

FIGS. 15A and 15B are diagrams for explaining an effect of a second embodiment.

FIGS. 16A and 16B are flowcharts for explaining processing for setting a target region.

FIGS. 17A and 17B are diagrams for explaining an effect of the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

However, Japanese Patent Laid-Open No. 2009-93287 does not mention processing illumination information indicating brightness distribution in accordance with a size of an object on which texture information is to be applied. Therefore, when a size of a target of decoration processing changes, a way in which brightness contrast according to illumination information indicating brightness distribution is added changes, and as a result, added metallic texture may change.

According to the present disclosure, it is possible to realize appropriate decoration processing that accords with a size of a target region.

### First Embodiment

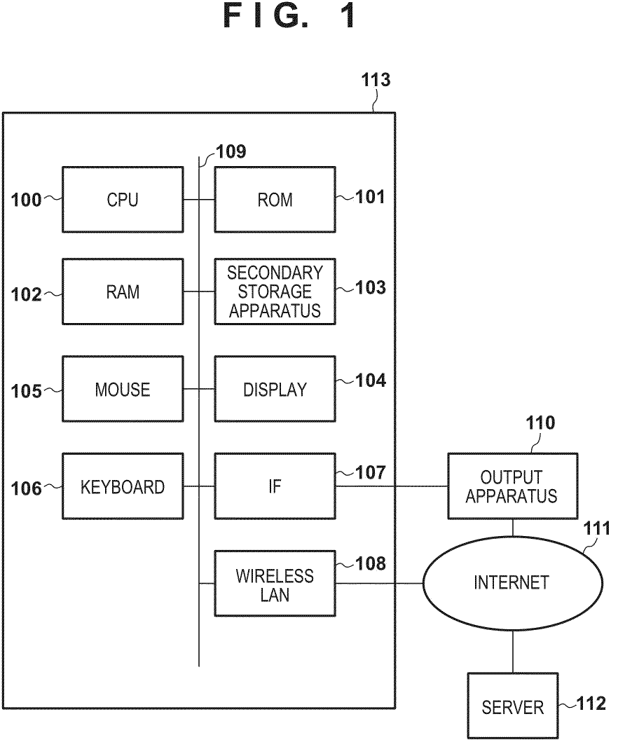

FIG. 1 is a block diagram for explaining an example of a hardware configuration of an image processing apparatus in the present embodiment. A central processing unit (CPU) 100 comprehensively controls an image processing apparatus 113; for example, the CPU 100 executes decoration processing to be described in the present embodiment in accordance with a program. A ROM 101 is a non-volatile memory and stores, for example, a program to be executed by the CPU 100. A RAM 102 is a volatile memory and is used, for example, as a memory for temporarily storing various kinds of information at the time of execution of a program by the CPU 100. A secondary storage apparatus 103, such as a hard disk, is a storage medium for storing, for example, an image file used in the present embodiment, and the like. A display 104 (a display unit) displays various user interface screens and presents, for example, a processing result of decoration processing, to a user. The display 104 may be configured to be capable of accepting user operation by being provided with a touch panel function. A control bus/data bus 109 connects the above respective units and the CPU 100 with each other. A mouse 105 and a keyboard 106 are operation units for accepting user operation and accept, for example, an instruction for executing decoration processing, from the user.

A wireless local area network (LAN) interface (IF) 108 is an interface for connecting the image processing apparatus 113 to an external network 111 via a wireless LAN. In FIG. 1, the Internet is indicated as an example of the network 111, and the image processing apparatus 113, for example, can acquire image data from an external server 112 connected to the Internet. An IF 107 is an interface for connecting the image processing apparatus 113 to an external output apparatus 110.

The output apparatus 110 is an apparatus for outputting an image and the like and is, for example, an inkjet printing apparatus including a data transfer unit, a printer control unit (including a CPU, a ROM, and a RAM), a printing unit, and the like. The output apparatus 110 is, for example, an inkjet printing apparatus that performs printing on a printing medium based on decoration data acquired from the image processing apparatus 113. In the present embodiment, the output apparatus 110 will be described as an inkjet printing apparatus; however, the output apparatus 110 may be a printing apparatus that uses another printing method, such as an electrophotographic method. The output apparatus 110 is also not limited to a printing apparatus and may be a display or projector that perform display output. The output apparatus 110 is connected to the Internet 111, and the image processing apparatus 113 can transmit and receive print data to be processed by the output apparatus 110 via the wireless LAN IF 108.

The image processing apparatus 113 is, for example, a general-purpose PC or a portable terminal, such as a smartphone. The block configuration of the image processing apparatus 113 is not limited to that illustrated in FIG. 1, and another component may be appropriately included in accordance with a function that can be realized by the image processing apparatus 113. For example, when the image processing apparatus 113 is a portable terminal, it may include an image capturing unit, such as a camera.

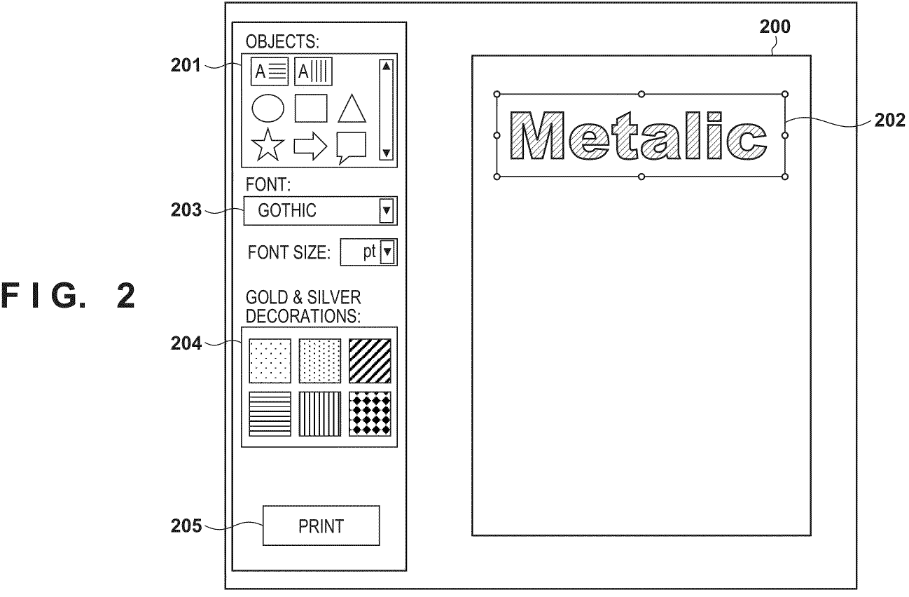

FIG. 2 is a diagram illustrating an example of a user interface (UI) screen of software in the present embodiment. The software is, for example, a decoration application for adding texture (a decoration effect) to an image by combining into image information texture information, such as metal, fabric, and canvas, and is stored in the ROM 101 or the secondary storage apparatus 103. The screen of FIG. 2 is displayed by execution of a decoration application by the user. A region 200 represents the entire image to be outputted by the output apparatus 110. A region 201 is a list of objects that can be placed in the region 200. Examples of objects included in the region 201 include a character string, a shape, and the like. The user can select a desired object from the region 201 and place it at a desired position in the region 200. FIG. 2 illustrates an example in which a character string “Metalic” is placed as an object 202. By selecting a desired character string and specifying a desired font and size in a region 203, the user can edit a font and a size of the selected character string. A region 204 is a list of decoration patterns that can be added to an object. By selecting a desired object and selecting a desired decoration pattern from the region 204, the user can add metallic texture to the object. A button 205 is a button for accepting a print instruction.

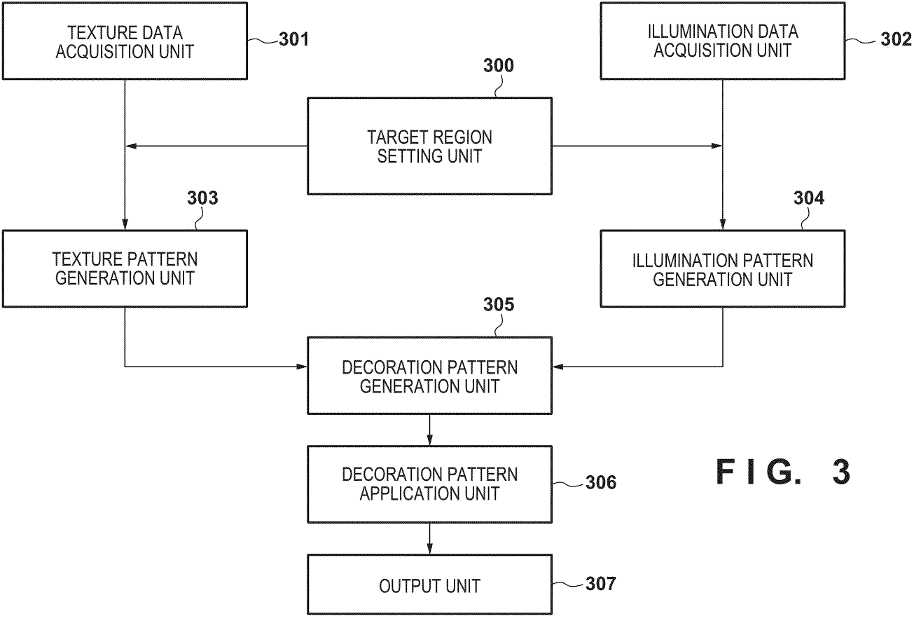

FIG. 3 is a block diagram illustrating an example of a configuration of a decoration application in the present embodiment. A target region setting unit 300 acquires coordinate information of an object selected to be a target of decoration processing by the user on a UI screen and calculates a size of the object. A texture data acquisition unit 301 acquires texture data associated with a decoration pattern selected by the user on the UI screen. An illumination data acquisition unit 302 acquires illumination data associated with the decoration pattern selected by the user on the UI screen. The illumination data will be described later.

A texture pattern generation unit 303 generates a texture pattern that accords with the object size calculated by the target region setting unit 300, using the texture data acquired by the texture data acquisition unit 301. An illumination pattern generation unit 304 generates an illumination pattern that accords with the object size calculated by the target region setting unit 300, using the illumination data acquired by the illumination data acquisition unit 302. As described above, in the present embodiment, processing of each of generation of the texture pattern and generation of the illumination pattern is executed in accordance with the object size.

A decoration pattern generation unit 305 generates a decoration pattern by combining the texture pattern generated by the texture pattern generation unit 303 and the illumination pattern generated by the illumination pattern generation unit 304. A decoration pattern application unit 306 applies the decoration pattern generated by the decoration pattern generation unit 305 to the object selected to be a target of decoration processing by the user on the UI screen. By this, the object to which the decoration pattern has been applied can obtain metallic texture. In response to pressing of the button 205 by the user on the UI screen, an output unit 307 prints by the output apparatus 110, which is an inkjet printer, an image including the object to which the decoration pattern has been applied by the decoration pattern application unit 306.

Here, a description will be given for characteristics of texture data used in the present embodiment. Characteristics of a metallic substance include a strong metallic gloss generated by occurrence of plasmon resonance between a free electron in the substance and an electromagnetic wave of illumination light. One of the important factors in a human perceiving metallic texture is that they perceive glossiness caused by this metallic gloss.

The perception of metallic texture based on the above glossiness also applies to the perception of a texture of a substance projected on a two-dimensional image. A human brain can perceive the metallic texture of a substance projected on an image, based on a statistical amount in the image having a high correlation with the above glossiness. It is known that a skewness of a luminance histogram contributes to a superficial glossiness of a substance in an image. Skewness is a statistical amount representing a bias of a histogram in an image and is calculated by Equation (1) using the number of pixels n in the image, a pixel value xi (i: 1, 2, ..., n), an average value x(-) of respective pixel values, and a standard deviation s.

$$\text{skewness} = \frac{n}{\left(n - 1\right) \left(n - 2\right)} {\sum }_{i = 1}^{n} {\left(\frac{{x}_{i} - \overline{x}}{s}\right)}^{3}$$

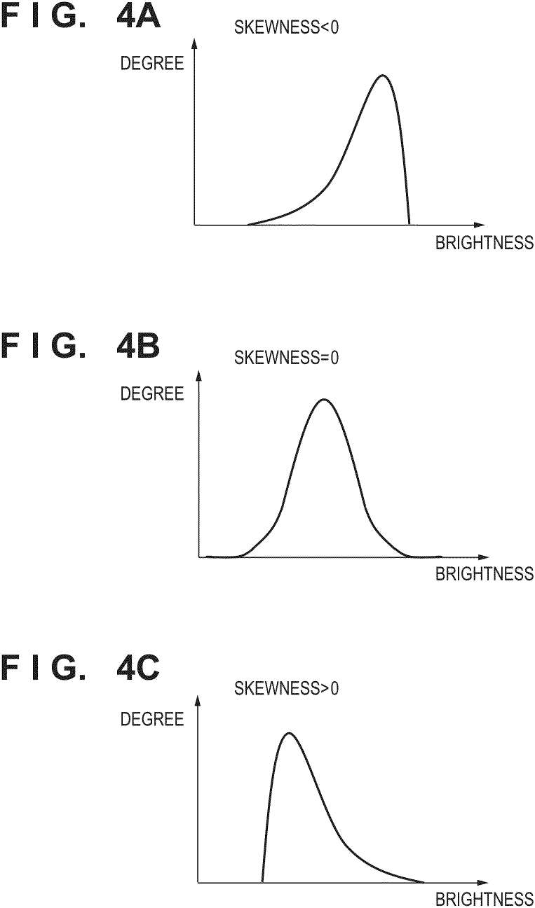

In a case of a bilaterally symmetrical distribution, such as a case of a normal distribution, as in FIG. 4B, the skewness is zero. In a case of a distribution in which a left end is longer as in FIG. 4A, the skewness takes a negative value, and in a case of a distribution in which a right end is longer as in FIG. 4C, the skewness takes a positive value. It is known that the larger the skewness of a luminance histogram in an image is to the positive side, the higher the superficial glossiness is perceived to be.

As described above, glossiness of a substance is an extremely important factor in the perception of metallic texture. That is, use of texture data whose skewness of a histogram of luminance in an image is larger on the positive side leads to improvement in superficial glossiness, that is, improvement in perceived metallic texture.

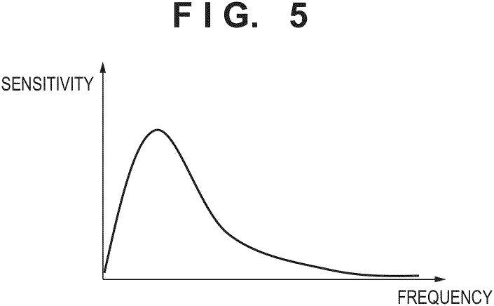

Frequency characteristics of texture data are also important factors in the perception of metallic texture from texture data. FIG. 5 is a diagram illustrating a frequency response characteristic of human vision with a horizontal axis as frequency and a vertical axis as contrast sensitivity. The frequency response characteristic of vision is a sensitivity characteristic indicating contrast that can be visually perceived by a person at a certain frequency. When roughness of texture changes due to, for example, scaling of texture data, a frequency characteristic of the texture changes; therefore, metallic texture perceived by a human changes. When creating texture data, it is desirable to make a texture of a roughness at which the aforementioned skewness of a luminance histogram is the highest considering the frequency response characteristics of vision. A description will be given below for an example of a method for generating luminance contrast data considering the frequency response characteristics of vision.

First, texture data is converted to luminance contrast data. When inputted texture data is RGB data, it is converted to YCbCr using Equations (2), (3), and (4). The equations for converting RGB to YCbCr are examples, and other conversion equations may be used.

$$\text{Y} = 0.299 \times \text{R} + 0.587 \times \text{G} + 0.114 \times \text{B}$$

$$\text{Cb} = \text{-0} \text{.169} \times \text{R} \text{-} \text{0} \text{.331} \times \text{G} + 0.5 \times \text{B}$$

$$\text{Cr} = 0.5 \times \text{R} \text{-} \text{0} \text{.419} \times \text{G} \text{-} \text{0} \text{.081} \times \text{B}$$

Next, a description will be given for a method for simulating perceived luminance contrast data by applying the frequency response characteristics of vision to the luminance contrast data. For example, Dooley’s approximate equation indicated below can be used, with the frequency response characteristics of vision as VTF.

$$\text{VTF} = 5.05 \times \text{exp} \left(\text{-0} \text{.138} \times π \text{lf} / 180\right) \times \left(1 \text{-} \text{exp} \left(\text{-0} \text{.1} \times π \text{lf} / 180\right)\right)$$

Here, 1 is a viewing distance [mm] and f is a frequency [cycle/mm]. 1 may be set to an expected viewing distance for an output image. In the above, a description has been given for an example in which Dooley’s approximate equation is used; however, the frequency response characteristic of vision is not limited to this. It may be any sensitivity characteristic so long as it indicates contrast that can be visually perceived by a person and accords with frequency.

Next, the luminance contrast data is converted to frequency data. A known technique such as two-dimensional Fourier transform (FFT: Fast Fourier Transform) can be used for conversion to frequency data. A frequency contained in data can be calculated based on the number of pixels of texture data and a size after printing. For example, a maximum frequency f [cycle/mm] included in texture data at a size after printing Size [mm] of the texture data is calculated by Equation (6), assuming the number of pixels n [pix] of the texture data.

$$\text{f} = \text{n} / \left(2 \times \text{Size}\right)$$

The frequency data obtained by multiplying the frequency response characteristic of vision to respective frequencies in the texture data calculated based on the number of pixels of the texture data and the size after printing as described above is inversely converted into luminance contrast data. As a result, perceived luminance contrast data simulating contrast perceived by a person can be calculated. In the present embodiment, a case where texture data is a rectangle is assumed as an example; however, the texture data is not always a rectangle. In that case, a frequency in the texture data may be calculated based on a horizontal width or a vertical width in accordance with a shape of the texture data. Alternatively, a frequency in the texture data may be calculated based on an average value of the vertical width and the horizontal width.

As described above, in order to express a realistic metallic texture, brightness contrast according to illumination data is important in addition to the characteristics of texture data. Here, a description will be given for an example of a method for calculating brightness contrast in the present embodiment.

First, as a first example, a standard deviation or variance of a luminance histogram of illumination data is given. A standard deviation Std is calculated by the following Equation (7) using the number of pixels n in an image, the pixel value xi (i: 1, 2, ..., n), and the average value x(-) of the respective pixel values. In addition, a variance is obtained by [Std]².

$$\text{Std} = \sqrt{\frac{1}{n} {\sum }_{i = 1}^{n} {\left({x}_{i} - \overline{x}\right)}^{2}}$$

Next, as a second example, a difference between a maximum value Ymax and a minimum value Ymin of a luminance value in illumination data is given. Alternatively, it may be a ratio of Ymax and Ymin.

Further, as a third example, a Michelson contrast calculated by the following Equation (8) may be used.

$$\text{Contrast} = \left(\text{Y\_max} \text{-} \text{Y\_min}\right) / \left(\text{Y\_max} + \text{Y\_min}\right)$$

In the following, a description will be given for an example in which a standard deviation of a luminance histogram of illumination data is used as a brightness contrast value.

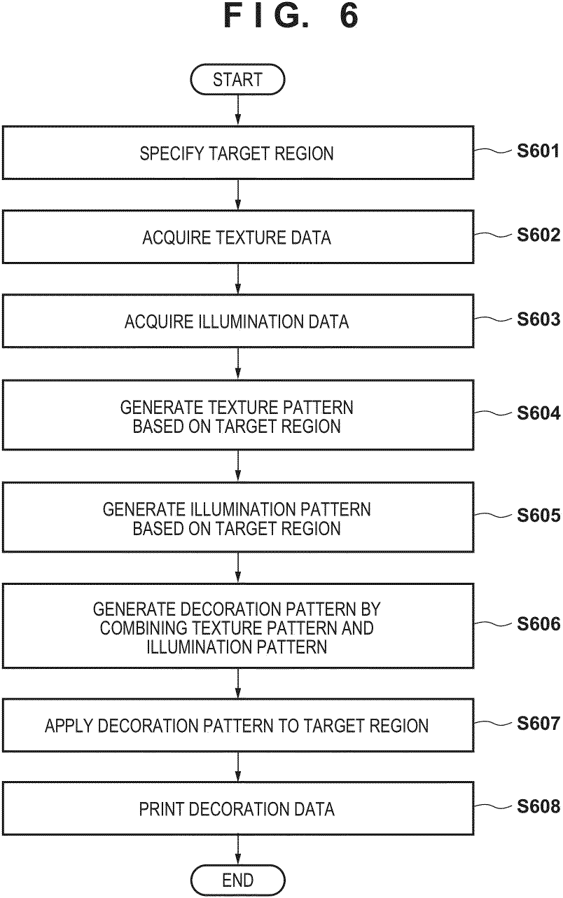

FIG. 6 is a flowchart for explaining decoration processing in the present embodiment. The processing of FIG. 6 is realized, for example, by the CPU 100 reading and executing a program stored in the ROM 101. In the following, the respective processes will be described to be performed by the respective blocks of FIG. 3 realized by the CPU 100.

In step S601, the target region setting unit 300 specifies a region to be a target of decoration processing and acquires a size of that region. For example, the target region setting unit 300 acquires coordinate information of an object selected to be a target of decoration processing by the user on the UI screen and calculates a size of that object.

In step S602, the texture data acquisition unit 301 acquires texture data for decorating the region specified in step S601. The texture data acquisition unit 301 acquires texture data associated with a decoration pattern selected by the user on the UI screen. In addition, the texture data acquisition unit 301 acquires a skewness Sr of a luminance histogram of perceived luminance contrast data in which the aforementioned frequency response characteristic of human vision is applied to texture data. Sr is calculated in advance using Equation (1) for each texture data and is held in association with the texture data. Further, the skewness Sr may be calculated when the texture data acquisition unit 301 acquires texture data. The skewness Sr here is a skewness value that serves as a reference. It is preferable that a skewness value of texture in a decoration pattern image displayed to the user on the UI screen is also Sr.

In step S603, the illumination data acquisition unit 302 acquires illumination data that is used for decoration of the region specified in step S601. More specifically, the illumination data acquisition unit 302 acquires illumination data associated with the decoration pattern selected by the user on the UI screen. In addition, the illumination data acquisition unit 302 acquires a brightness contrast Cr of the illumination data. Cr is calculated in advance using Equation (7) for each illumination data and is held in association with the illumination data. Further, the brightness contrast Cr may be calculated when the illumination data acquisition unit 302 acquires illumination data. The brightness contrast Cr here is a contrast value that serves as a reference. It is preferable that a contrast value of illumination in a decoration pattern image displayed to the user on the UI screen is also Cr.

In step S604, the texture pattern generation unit 303 generates a texture pattern based on the size of the region calculated in step S601. The texture pattern generation unit 303 generates a texture pattern that accords with the object size calculated by the target region setting unit 300, using the texture data acquired by the texture data acquisition unit 301.

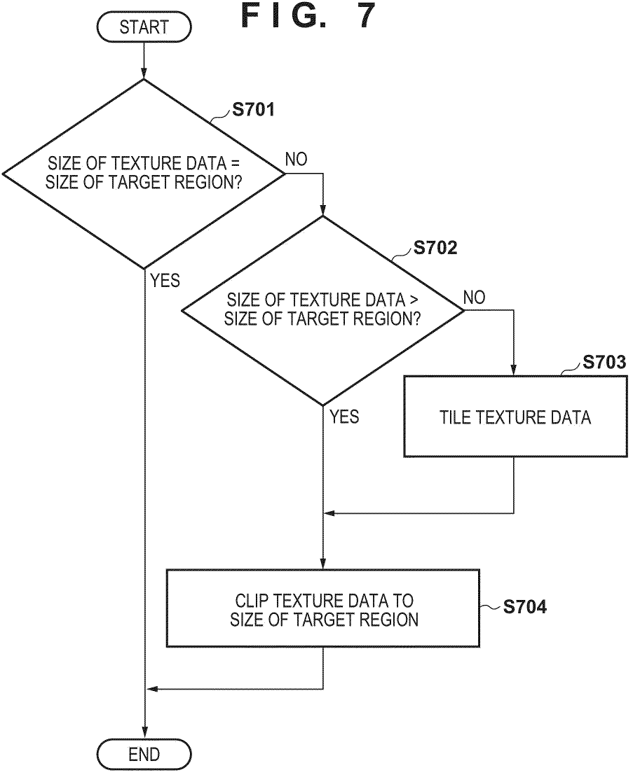

FIG. 7 is a flowchart for explaining processing for generating a texture pattern in step S604. In step S701, the texture pattern generation unit 303 determines whether or not the object size calculated in step S601 is equal to a size of a texture image represented by the texture data selected in step S602. When it is determined to be equal, the texture pattern generation unit 303 outputs the texture data as a texture pattern and terminates the processing of FIG. 7. Meanwhile, if it is determined to not be equal, the processing proceeds to step S702.

In step S702, the texture pattern generation unit 303 determines whether or not the size of the texture image represented by the texture data selected in step S602 is larger than the object size calculated in step S601. If it is determined to be larger, the processing proceeds to step S704. Meanwhile, if it is determined to not be larger, that is, the size of the texture image represented by the texture data is smaller than the object size, the processing proceeds to step S703. In step S703, the texture pattern generation unit 303 tiles the texture data until its size is larger than or equal to the object size and then generates a texture pattern. After step S703, the processing proceeds to step S704.

In step S704, the texture pattern generation unit 303 aligns the texture pattern and the object size and then clips the texture pattern to the object size. Methods for aligning the texture pattern and the object size include aligning at upper left coordinates, aligning at lower left coordinates, aligning at upper right coordinates, aligning at lower right coordinates, and aligning at center coordinates. When it is determined in step S702 that the size of the texture data is larger than the object size, the texture pattern generation unit 303 treats the clipped texture data as a texture pattern. The texture pattern generation unit 303 outputs the texture pattern clipped in step S704 and terminates the processing of FIG. 7. The texture pattern generation unit 303 generates perceived luminance contrast data by applying the aforementioned frequency response characteristics of human vision to the generated texture pattern. Furthermore, the texture pattern generation unit 303 calculates a skewness S of a histogram of perceived luminance contrast data using Equation (1).

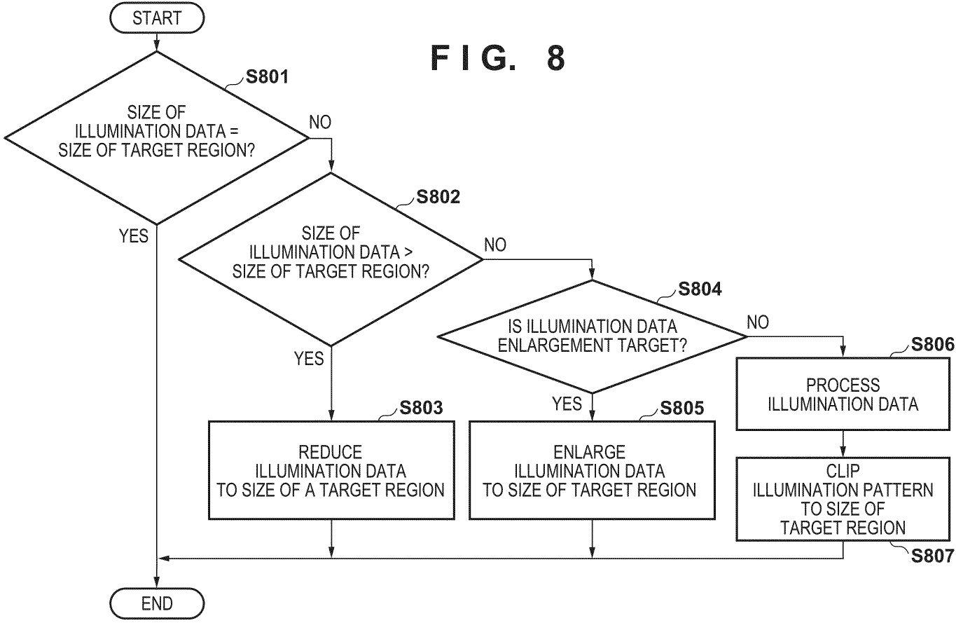

FIG. 6 is referenced again. In step S605, the illumination pattern generation unit 304 generates an illumination pattern based on the size of the region calculated in step S601. The illumination pattern generation unit 304 generates an illumination pattern that accords with the object size calculated by the target region setting unit 300, using the illumination data acquired by the illumination data acquisition unit 302. The generation of the illumination pattern will be described with reference to FIG. 8.

FIG. 8 is a flowchart for explaining processing for generating an illumination pattern in step S605. In step S801, the illumination pattern generation unit 304 determines whether or not the object size calculated in step S601 is equal to a size of a region of luminance distribution represented by the illumination data acquired in step S603. When it is determined to be equal, the illumination pattern generation unit 304 outputs the illumination data as an illumination pattern and terminates the processing of FIG. 8. Meanwhile, if it is determined to not be equal, the processing proceeds to step S802.

In step S802, the illumination pattern generation unit 304 determines whether or not the size of the region of luminance distribution represented by the illumination data acquired in step S603 is larger than the object size calculated in step S601. If it is determined to be larger, the processing proceeds to step S803. If it is determined to not be larger, that is, the size of the region of luminance distribution represented by the illumination data is smaller than the object size, the processing proceeds to step S804.

In step S803, the illumination pattern generation unit 304 reduces the illumination data such that the size of the region of the luminance distribution represented by the illumination data acquired in step S603 is the same as the object size calculated in step S601 and then generates an illumination pattern. Further, the illumination pattern generation unit 304 calculates a brightness contrast C of the generated illumination pattern. Then, the illumination pattern generation unit 304 performs adjustment for adding metallic texture that is closer to a reference by confirming whether Sr, Cr, S, and C values acquired or calculated in steps S602, S603, S604, and S605 satisfy the following Equation (9).

$$\text{C} / \text{S} \geq \text{Cr} / \text{Sr}$$

As described above, in order to add a more realistic metallic texture, a skewness of a luminance histogram of metal texture and brightness contrast of illumination are necessary. Therefore, in order to add metallic texture that is independent of object size, it is preferable that the ratio C/S of the skewness S of a texture pattern and the contrast C of an illumination pattern be greater than or equal to a reference Cr/Sr. The reference Cr/Sr is a value representing an impression of metallic texture when the user selects a decoration pattern on the UI screen. Since a texture pattern is generated by tiling or trimming texture data, its skewness S and Sr take on substantially equal values. That is, confirmation according to Equation (9) means confirmation of whether metallic texture deteriorates by the brightness contrast C of the generated illumination pattern becoming smaller than the reference Cr in accordance with the object size.

If a relationship (condition) of Equation (9) is not satisfied, it is assumed that the brightness contrast C of the generated illumination pattern is small, and the illumination pattern is adjusted by scaling the size of the illumination pattern by ± x% (x ≤ 10) with respect to the object size. When enlarging the illumination pattern at the time of adjustment of the illumination pattern, the adjusted illumination pattern is clipped to the object size. There are cases where, by enlarging the illumination pattern, the ratio of the number of pixels of a bright portion and the number of pixels of a dark portion of illumination in the object is changed and brightness contrast increases. When reducing the illumination pattern at the time of adjustment of the illumination pattern, the adjusted illumination pattern becomes smaller than the object size; therefore, a region that is lacking with respect to the object size is filled with the minimum value of luminance in the illumination pattern. By the pixels of a dark portion of illumination in the object increasing, the ratio of the number of pixels of a bright portion and the number of pixels of a dark portion of illumination in the object is changed and the brightness contrast increases. The illumination pattern generation unit 303 calculates the brightness contrast value C again for the adjusted illumination pattern and repeats the adjustment by increasing the value of x until the relationship of Equation (9) is satisfied. If Equation (9) is not satisfied by performing processing up to x = 10, a value of x at which the left side of Equation (9) is the largest will be adopted. By doing so, it is possible to add metallic texture that is closer to the reference.

In the above, a description has been given for an example in which the brightness contrast value C of illumination is adjusted by scaling the size of the illumination pattern; however, the brightness contrast value C may be adjusted by expanding the luminance range of the illumination pattern. Further, the brightness contrast value C may be adjusted by combining scaling of the size of the illumination pattern and expansion of the luminance range. After step S803, the processing of FIG. 8 is ended.

In step S804, the illumination pattern generation unit 304 determines whether or not the region indicating the luminance distribution represented by the illumination data acquired in step S603 is an enlargement target. If it is determined to be an enlargement target, the processing proceeds to step S805. If it is determined to not be an enlargement target, the processing proceeds to step S806.

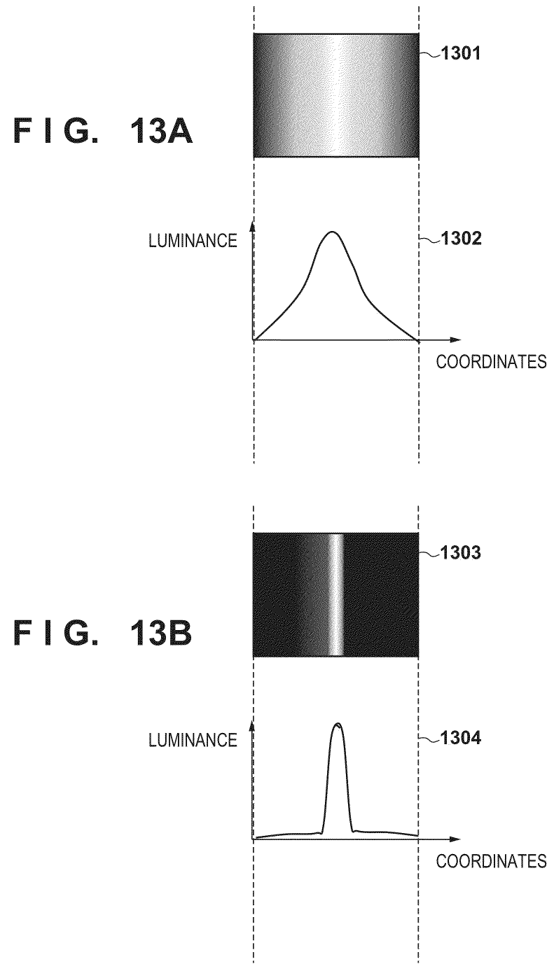

In step S804, the illumination pattern generation unit 304 determines whether the illumination data is an enlargement target based on a predetermined gradient and reference value of a change in luminance of the illumination pattern. FIGS. 13A and 13B are diagrams illustrating an example of illumination data and illustrate illumination data 1301 and 1303. In addition, a luminance change 1302 indicates a horizontal luminance change of the illumination data 1301, and a luminance change 1304 indicates a horizontal luminance change of the illumination data 1303. As illustrated in FIGS. 13A and 13B, a gradient of brightness contrast of the illumination data 1301 is relatively gentle (less than or equal to the reference value). Meanwhile, a gradient of brightness contrast of the illumination data 1303 is relatively steep (larger than the reference value). Illumination data with a gentle gradient of brightness contrast, such as the illumination data 1301 does not change much in its resulting impression even when it is scaled to fit the object size. Meanwhile, when illumination data with a steep gradient of brightness contrast, such as the illumination data 1303, is enlarged to match the object size, the gradient of brightness contrast becomes gentle, and as a result, there may be a case where an intended impression of brightness contrast is not given. In such a case, rather than changing the scale of illumination data, performing tiling processing results in a smaller change in the gradient of brightness contrast, and as a result, it is possible to reduce the change in the impression of brightness contrast given to the user. As described above, in the present embodiment, a method of generating the illumination pattern is changed depending on the type of illumination data and the intended effect. In order to switch processing depending on the type of illumination data, a configuration may be taken so as to add in advance information on a processing method suitable for each illumination data, and the illumination pattern generation unit 304 may refer to the information at the time of processing.

In step S805, the illumination pattern generation unit 304 enlarges the illumination data such that the size of the region of luminance distribution represented by the illumination data acquired in step S603 is the same as the object size calculated in step S601 and then generates an illumination pattern. Here, similarly to the description in step S803, the illumination pattern generation unit 304 performs confirmation according to Equation (9) and adjustment of brightness contrast for the generated illumination pattern. After step S805, the processing of FIG. 8 is ended.

Meanwhile, in step S806, the illumination pattern generation unit 304 tiles the illumination data until its size is larger than or equal to the object size and then generates an illumination pattern. In step S807, the illumination pattern generation unit 304 aligns the illumination pattern and the object size and then clips the illumination pattern to the object size. Methods for aligning the illumination pattern and the object size include aligning at upper left coordinates, aligning at lower left coordinates, aligning at upper right coordinates, aligning at lower right coordinates, and aligning at center coordinates. The illumination pattern generation unit 304 outputs the illumination pattern clipped in step S807 and terminates the processing of FIG. 8.

Further, in the above, a description has been given for an example in which processing is performed assuming that the illumination data is in a raster format; however, the illumination data may be in a vector format. When the illumination data is held in a vector format, relative coordinates of representative points and color information at the coordinates are held in the illumination data. Then, the illumination pattern generation unit 304 needs only rasterize the illumination data in a vector format in the object size. At that time, colors at other coordinates between the representative points may be calculated by interpolation from color information at the representative points.

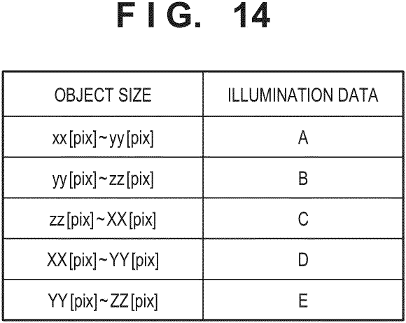

When it is determined in step S802 to not be larger, that is, the size of the region indicating the luminance distribution represented by the illumination data is smaller than the object size, the processing of step S805 may be executed without executing the processing of steps S804, S806, and S807. In addition, it is not always necessary to scale one illumination data in accordance with the object size, and the illumination data to be used may be switched for each object size. Specifically, as illustrated in FIG. 14, a range of object sizes and appropriate illumination data may be held in advance in association with each other, and the illumination data to be used may be switched in accordance with the object size actually calculated in step S601. When the selected illumination data is larger than the object size, clipping is performed in accordance with the object size. Further, the illumination data may be held as a bitmap image or as vector data.

In addition, in the above, it has been described that when a gradient of brightness contrast is relatively steep, it is determined in step S804 that illumination data is not an enlargement target, and tiling processing is executed in step S806. However, another processing may be performed in step S806 instead of tiling processing. For example, a region of luminance distribution represented by the illumination data may be positioned at the center of a target region of decoration processing, and pixels may be supplemented about the periphery of the target region so as to maintain the luminance distribution. Such a configuration can also reduce a change in an impression of brightness contrast given to the user.

FIG. 6 is referenced again. In step S606, the decoration pattern generation unit 305 generates a decoration pattern by combining the texture pattern generated in step S604 and the illumination pattern generated in step S605. The decoration pattern generation unit 305 performs combination processing such that the contrast of the texture pattern generated by the texture pattern generation unit 303 is increased by the illumination pattern generated by the illumination pattern generation unit 304. Soft light and overlay, which are known layer combination techniques, may be used for combination processing. Assuming that a pixel value of a texture pattern is a, a pixel value of an illumination pattern is b, and a pixel value of a decoration pattern is c, a result of soft light processing is calculated by Equation (10), and a result of overlay processing is calculated by Equation (11).

$$\text{c} = \left\{\begin{matrix}2 a b + {a}^{2} \left(1 - 2 a b\right) & \left(i f b < 0.5\right) \\ 2 a \left(1 - b\right) + \sqrt{a} \left(2 b - 1\right) & \left(i f b \geq 0.5\right)\end{matrix}\right.$$

$$\text{c} = \left\{\begin{matrix}2 a b & \left(i f a < 0.5\right) \\ 1 - 2 \left(1 - a\right) \left(1 - b\right) & \left(i f a \geq 0.5\right)\end{matrix}\right.$$

In step S607, the decoration pattern application unit 306 applies the decoration pattern generated by the decoration pattern generation unit 305 to the object selected to be a target of decoration processing by the user on the UI screen. If the object is a shape or character string other than a rectangle, the decoration pattern is clipped in accordance with the shape and then combined.

In step S608, the output unit 307 transmits to the output apparatus 110, which is an inkjet printer, image data including the object to which the decoration pattern has been applied by the decoration pattern application unit 306 and causes the output apparatus 110 to print the image data. Then, the processing of FIG. 6 is ended.

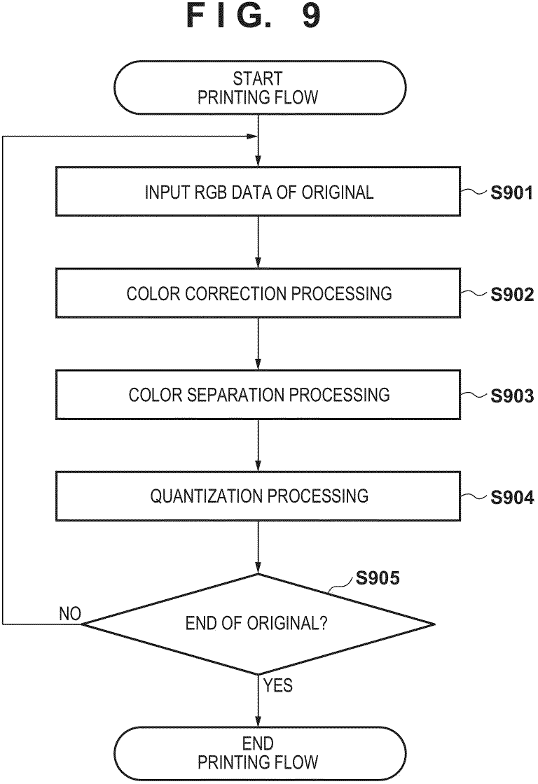

FIG. 9 is a flowchart for explaining printing processing in the output apparatus 110, which is an inkjet printer. The processing of FIG. 9 begins when the output apparatus 110 receives image data including an object to which the decoration pattern has been applied, transmitted in step S608. Here, a description will be given assuming that the image data is RGB image data.

In step S901, the printer control unit of the output apparatus 110 inputs RGB image data as an original to be printed. Next, in step S902, the printer control unit performs color correction processing for converting an RGB color of the original into an RGB value suitable for printing. For the color correction processing, known suitable processing may be used. In step S903, the printer control unit performs color separation processing for converting the RGB value into a usage amount of each ink. As a method for color separation processing, known suitable processing may be used. In step S904, the printer control unit performs quantization processing for converting a usage amount of each color ink of a print head into the presence or absence of a dot to be actually printed. For the quantization processing, techniques such as known error diffusion processing and dither processing may be used. When quantized dot data is sent to the print head and preparation of the dot data for one scan is completed, the printer control unit performs actual printing using the print head on a printing sheet. In step S905, the printer control unit determines whether or not processing has been completed for all of the pixels of the image data. If it is determined that the processing has been completed for all the pixels, the processing of FIG. 9 is ended. Meanwhile, when it is determined that the processing has not been completed for all the pixels, the processing is repeated from step S901.

As described above, in the present embodiment, texture data and illumination data are held in a state in which they are separate and after each process is performed in accordance with a size of a target region, the texture data and the illumination data are combined to generate a decoration pattern. Hereinafter, an effect of this will be described.

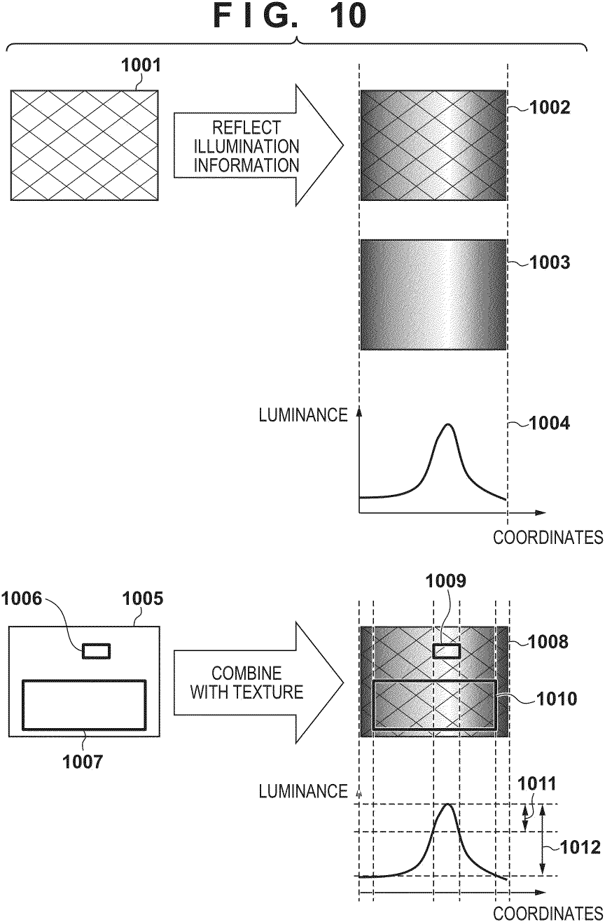

FIG. 10 is a diagram illustrating a case where a region of illumination data is not changed in accordance with an object size. An image 1002 is an image after reflecting illumination data in an image 1001. Brightness contrast, such as an image 1003, is added to the image 1001 according to illumination data. A graph 1004 is a graph representing a horizontal change in luminance of the image 1003. With this brightness contrast, the image 1002 can represent a more realistic metallic texture than the image 1001.

An image 1005 of FIG. 10 is an image on which metallic texture is to be added. Two objects 1006 and 1007 are placed in the image 1005. The size of object 1006 is relatively small and the size of object 1007 is relatively large. By combining the image 1002 into the image 1005, metallic texture is added to these two objects 1006 and 1007. An image 1008 is an image in which the image 1002 has been combined into the image 1005. An object 1009 corresponds to the object 1006 and an object 1100 corresponds to the object 1007. A brightness contrast 1011 represents brightness contrast according to illumination data within the object 1009, and a brightness contrast 1012 represents brightness contrast according to illumination data within the object 1010. It can be seen that since the positions in the image and sizes of the objects 1009 and 1010 are different, a way in which brightness contrast according to the illumination data is added is different. That is, the brightness contrast according to illumination information, which is an important element for expressing metallic texture more realistically, changes depending on the size and the position in the image of the object to which the metallic texture is to be added.

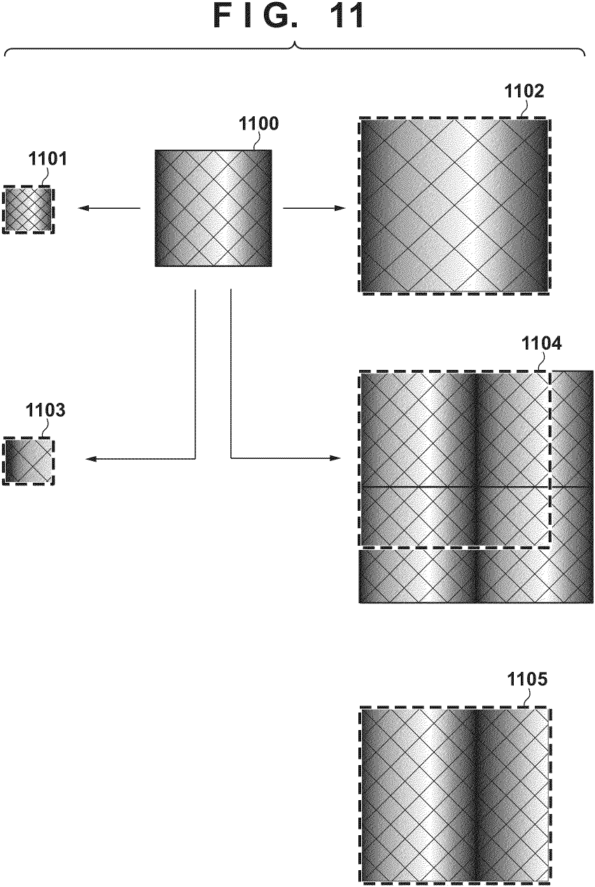

FIG. 11 is a diagram illustrating a case where texture data and illumination data are processed without separating them. An image 1100 is a single image with both texture and brightness contrast according to illumination. A description will be given for a case where the image 1100 is used to add metallic texture to objects of different sizes. An image 1101 indicates a state in which the image 1100 has been reduced and then applied to a relatively small object. Meanwhile, an image 1102 indicates a state in which the image 1100 has been enlarged and then applied to a relatively large object. Both the images 1101 and 1102 have approximately the same brightness contrast values according to illumination. Meanwhile, due to an effect of scaling, roughness of texture (frequency of a texture image) is different in the images 1101 and 1102. Therefore, when the images 1101 and 1102 are compared, an impression according to the brightness contrast of illumination is substantially equal; however, an impression according to skewness of texture considering frequency characteristics is different. Therefore, in the method for applying to an object a single image comprising both texture and brightness contrast according to illumination by scaling, if the size of the object is different, an impression of metallic texture added to the object is different.

An image 1103 is an object of the same size as the image 1101. The image 1103 is a result of trimming and applying a portion of the image 1100. Meanwhile, a bold dotted line in an image 1104 is an object of the same size as the image 1102. The image 1104 is a result of placing and applying a plurality of images that are the same as the image 1100 side by side. An image 1105 is a result of clipping along the outline of the object from the image 1104. Since the frequency component of texture of the images 1103 and 1105 is substantially equal, the values of skewness of a luminance histogram considering frequency characteristics are substantially equal. However, due to an effect of trimming and tiling, the values of brightness contrast according to illumination differ in the images 1103 and 1105. Therefore, when the images 1103 and 1105 are compared, an impression according to the skewness of texture considering frequency characteristics is substantially equal, but an impression according to the brightness contrast of illumination is different. Therefore, in the method for applying, to an object, a single image comprising both texture and brightness contrast according to illumination without scaling, if the size of the object is different, an impression of metallic texture added to the object is different.

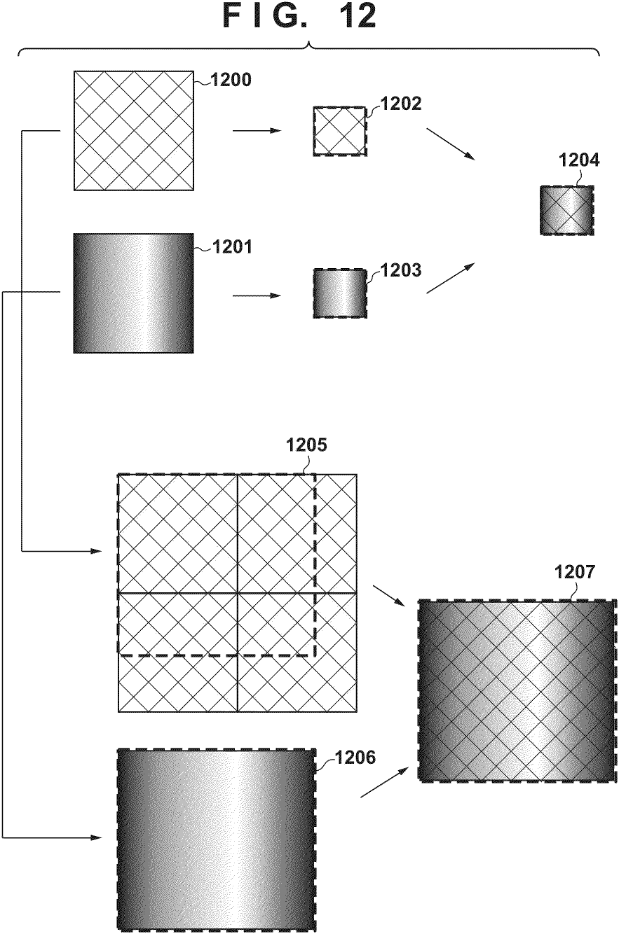

FIG. 12 is a diagram for explaining an effect of processing texture data and illumination data separately. A description will be given for a case where metallic texture is added to objects of different sizes using an image 1200 and an image 1201. The upper portion of FIG. 12 represents processing for a relatively small object. An image 1202 represents a state in which the image 1200 is trimmed in accordance with the object size. An image 1203 represents a state in which the image 1201 is reduced in accordance with the object size. An image 1204 is a result of combining the image 1202 and the image 1203 and applying it to the object. Meanwhile, the lower portion of FIG. 12 represents processing for a relatively large object. Thick dotted lines of an image 1205, an image 1206, and an image 1207 represent the object. The image 1205 represents a state in which the image 1200 is tiled in accordance with the object size. The image 1206 represents a state in which the image 1201 is enlarged to the object size. An image 1207 is a result of clipping a tiling result of the image 1205 in accordance with the object size, combining it with the image 1206, and then applying that to the object. The texture data is processed so as not to substantially change the frequency so that an impression according to texture the images 1204 and 1207 does not change. In addition, the illumination data is processed so as not to substantially change the brightness contrast so that an impression according to illumination of the image 1204 and the image 1207 does not change.

That is, according to the present embodiment, compared with the method in which a single image comprising both texture and brightness contrast according to illumination is scaled and then applied to an object, a difference in the degrees of skewness of texture between the two objects, one large and one small, is reduced. In addition, compared with the method in which a single image comprising both texture and brightness contrast according to illumination is applied to an object without scaling, a difference in brightness contrast according to illumination between the two objects, one large and one small, is reduced. This, when expressed by a ratio of skewness of texture in each object to brightness contrast according to illumination, is as follows. First, calculation is performed from a ratio in the processing of the present embodiment. Assuming that the skewness of texture is S1 and the brightness contrast according to illumination is C1 in the image 1204, their ratio is C1/S1. Next, assuming that the skewness of texture is S2 and the brightness contrast according to illumination is C2 in the image 1207, their ratio is C2/S2. Therefore, a ratio of the ratio of skewness of texture to the brightness contrast according to illumination in the image 1204 to the ratio of skewness of texture to the brightness contrast according to illumination in the image 1207 is (S1 · C2) / (C1 · S2). Similarly, assuming that the skewness of texture is S3 and the brightness contrast according to illumination is C3 in the image 1101 and the skewness of texture is S4 and the brightness contrast according to illumination is C4 in the image 1100, a ratio in the conventional scaling method is (S3 · C4) / (C3 · S4). Similarly, assuming that the skewness of texture is S5 and the brightness contrast according to illumination is C5 in the image 1103, a ratio in the conventional method without scaling is (S5 · C4) / (C5 · S4). Thus, an effective range in the present embodiment is as in the following Equation (12).

$$\frac{S 3 * C 4}{C 3 * S 4} > \frac{S 1 * C 2}{C 1 * S 2} > \frac{S 5 * C 4}{C 5 * S 4}$$

Further, in the present embodiment, due to these effects, it is possible to reduce deterioration in metallic texture or a difference in an impression of metallic texture caused by the size and position of an object, compared with the aforementioned two conventional techniques. Further, it is possible to reduce a difference in an impression of metallic texture between a plurality of objects of different sizes and positions.

As described above, according to the present embodiment, by generating an illumination pattern in accordance with the size of an object to be processed, it is possible to reduce deterioration of metallic texture or a difference in an impression of metallic texture caused by the size and the position of the object. In addition, it is possible to reduce a difference between impressions of metallic texture between a plurality of objects of different sizes and positions. In the present embodiment, although luminance is used when calculating the skewness of a texture pattern or the brightness contrast of an illumination pattern, a numerical value indicating another brightness, such as brightness, may be used.

### Second Embodiment

In the first embodiment, it has been described that by generating an illumination pattern in accordance with the size of a region to be processed, deterioration of metallic texture or a difference in an impression of metallic texture caused by the size and position of the region can be reduced. Hereinafter, a second embodiment will be described with reference to points different from the first embodiment.

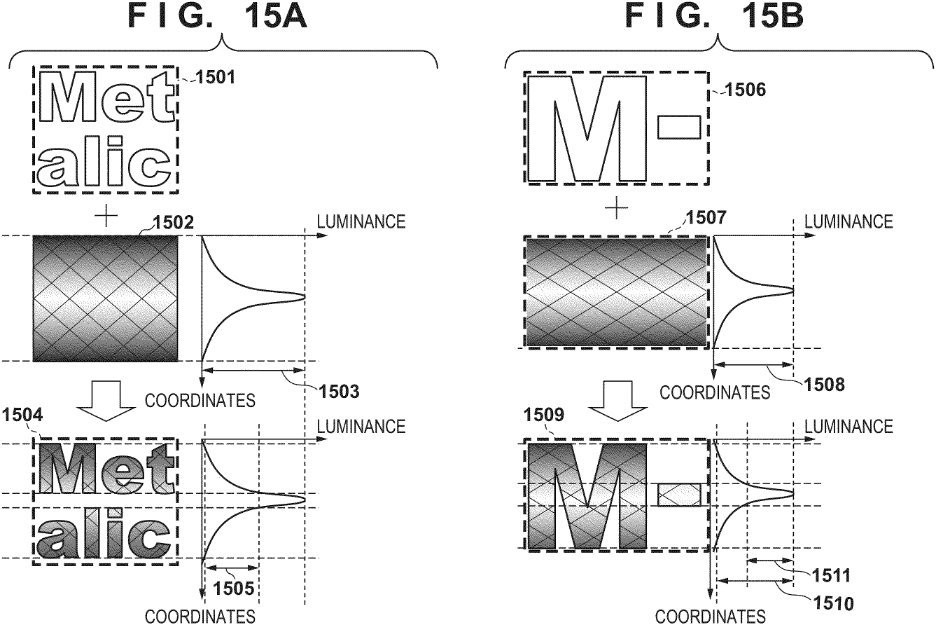

A region 1501 of FIG. 15A is a region on which decoration processing is to be applied in the present embodiment. The region 1501 contains character string objects that have been broken into two lines. An image 1502 is a decoration pattern to be applied to the region 1501, generated by the decoration processing in the first embodiment. A brightness contrast 1503 indicates the brightness contrast of an illumination pattern in the image 1502. An image 1504 is a result of applying the image 1502 to the region 1501. A brightness contrast 1505 indicates the brightness contrast of an illumination pattern in the image 1504. The region 1501 is configured by two lines of a character string and the highlight portion of the image 1502 is positioned in the space between the lines. Therefore, the brightness contrast of illumination in the decoration pattern applied to the actual character string of the region 1501 becomes smaller than the brightness contrast 1503 as indicated by the brightness contrast 1505.

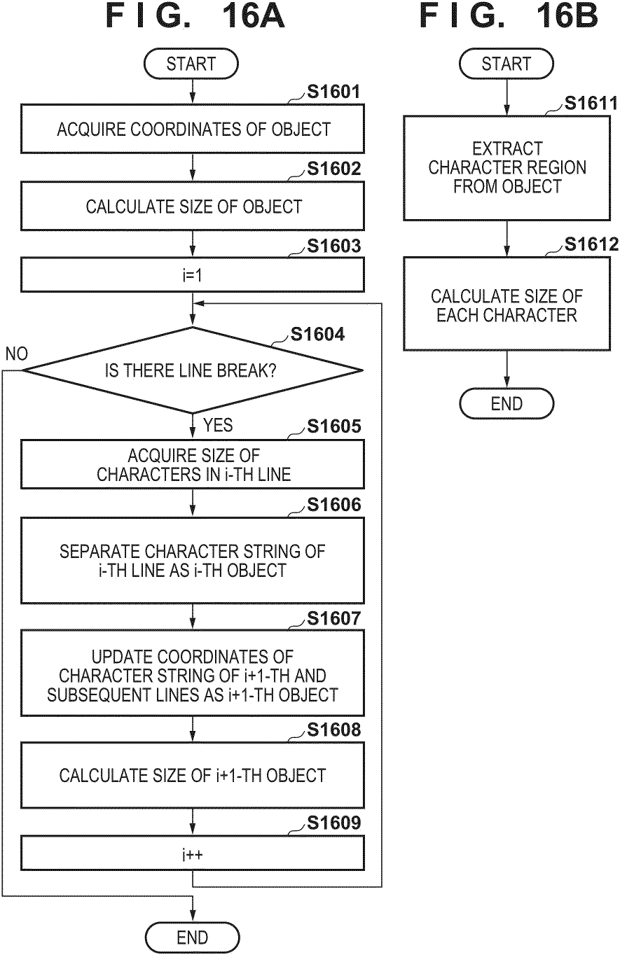

In the present embodiment, additional processing is performed at the time of setting a region to be a target of decoration processing. In the present embodiment, the processing of FIG. 16A is performed instead of the processing of step S601 of FIG. 6. FIG. 16A is a flowchart for explaining processing for setting a target region in the present embodiment. The processing of FIG. 16A is realized, for example, by the CPU 100 reading and executing a program stored in the ROM 101. In the following, the respective processes will be described to be performed by the respective blocks of FIG. 3 realized by the CPU 100.

In step S1601, the target region setting unit 300 acquires coordinate information of a region including an object selected as a target of decoration processing by the user on the UI screen. In step S1602, the target region setting unit 300 calculates the size of the region including the object based on the coordinate information acquired in step S1601.

In the processing of step S1603 and thereafter, the region including the object is divided in accordance with the presence or absence of a line break in the region including the object, and the respective divided regions are extracted. In step S1603, the target region setting unit 300 sets a parameter i for dividing the region including the object, and sets i = 1 as an initial value.

In step S1604, the target region setting unit 300 determines whether or not there is a line break in the region including the object. Regarding the determination of the presence or absence of a line break, it is determined that there is a line break, for example, when a pixel value other than white is detected after a line of an RGB pixel value (255,255,255) is repeated. If there is no line break as a result of the determination in step S1604, the processing proceeds to step S1610, and the processing for setting a target region in FIG. 16A is terminated. If it is determined that there is a line break in step S1604, the processing proceed to step S1605.

In step S1605, the target region setting unit 300 acquires the size of a character string of the first line. In step S1606, the target region setting unit 300 separates the character string of the first line as a first object region and extracts it. The target region setting unit 300 sets the size of the first object region based on the size of the character string acquired in step S 1605.

In step S1607, the target region setting unit 300 sets coordinates of a region including a character string of the second and subsequent lines. The target region setting unit 300 updates the coordinate information acquired in step S1601 based on the size of the first object region acquired in step S1605. In step S1608, the target region setting unit 300 calculates the size of the region including a character string of the second and subsequent lines based on the coordinate information acquired in step S1607. The target region setting unit 300 calculates the size of the region including a character string of the second and subsequent lines based on the size of the region including the object calculated in step S1602 and the size of the first object region calculated in step S1605.

In step S1609, i is incremented, and the processing proceeds to step S1604. Thereafter, by repeating the processing of steps S1604 to S1609, character strings broken into new lines are divided into separate object regions and then extracted.

In step S602 and thereafter of FIG. 6, a decoration pattern corresponding to each object size is generated for each object that has been separated in FIG. 16A and then is applied to each object.

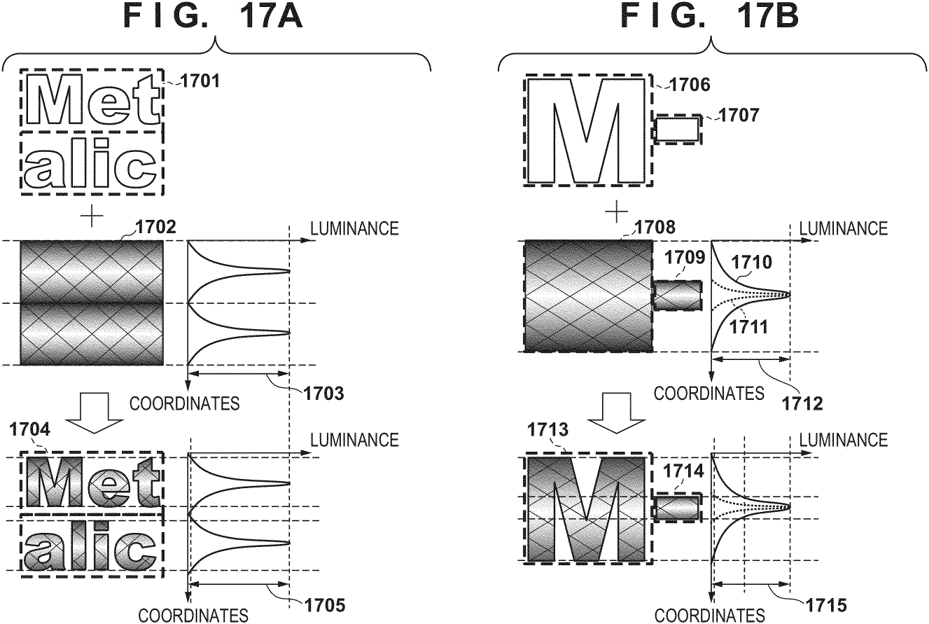

FIG. 17A is a diagram illustrating an effect of the present embodiment. A region 1701 in FIG. 17A indicates a state in which the processing of the present embodiment is applied to the region 1501. In accordance with the target region setting processing in FIG. 16A, “Met” on the first line and “alic” on the second line are set as different objects.

An image 1702 is a decoration pattern to be applied to the region 1701, generated by the decoration processing in the present embodiment. A brightness contrast 1703 indicates the brightness contrast of an illumination pattern in the image 1702. An image 1704 is a result of applying the image 1702 to the image 1701. A brightness contrast 1705 indicates the brightness contrast of an illumination pattern in the image 1704. In the present embodiment, since a decoration pattern is generated and applied to each of the character strings of respective rows of the image 1701, the highlight portion of illumination of the image 1702 is applied to each character string. It is possible to make the brightness contrast of illumination in the decoration pattern applied to the actual character string of the image 1701 be substantially the same value as that of the brightness contrast 1703 as indicated by the brightness contrast 1705.

FIG. 15B is a diagram for explaining another case where an effect that can reduce deterioration in metallic texture or a difference in an impression of metallic texture caused by the size and position of an object is not sufficiently obtained.

A region 1506 of FIG. 15B is a region on which decoration processing is to be applied. The region 1506 includes two characters “M” and “-”. An image 1507 is a decoration pattern to be applied to the image 1506. A brightness contrast 1508 indicates the brightness contrast of an illumination pattern in the image 1507. An image 1509 is a result of applying the decoration pattern 1507 to the object 1506. A brightness contrast 1510 indicates the brightness contrast of an illumination pattern in “M” of the image 1509. A brightness contrast 1511 indicates the brightness contrast of an illumination pattern “-” of the image 1509. The brightness contrast 1510 becomes substantially the same value as that of the brightness contrast 1508, while the brightness contrast 1511 becomes smaller than the brightness contrast 1508. That is, a difference in the shape of a character changes the way the brightness contrast is added according to the illumination pattern for each character.

In the present embodiment, the processing of FIG. 16B is performed on such an object instead of the processing of step S601 of FIG. 6. The processing of FIG. 16B is realized, for example, by the CPU 100 reading and executing a program stored in the ROM 101.

In step S1611, the target region setting unit 300 extracts a character region from an object selected as a target of decoration processing by the user on the UI screen. A known method such as OCR may be used as the extraction method. In step S1612, the target region setting unit 300 calculates the size of each character as separate object regions based on the character region information acquired in step S1611. In step S602 and thereafter of FIG. 6, a decoration pattern corresponding to each object size is generated for each object region extract in step S601 and then is applied to each object.

FIG. 17B is a diagram for explaining an effect of the processing of FIG. 16B. The regions 1706 and 1707 in FIG. 17B indicate a state in which the processing of FIG. 16B is applied to the region 1506. By the processing of FIG. 16B, “M” which is the first character and “-” which is the second character are extracted as different object regions.

Images 1708 and 1709 are decoration patterns to be applied to images 1706 and 1707, respectively. A graph 1710 represents the luminance distribution of an illumination pattern in the image 1708, and a graph 1711 represents the luminance distribution of an illumination pattern in the image 1709. A brightness contrast 1712 is the brightness contrast of the graphs 1710 and 1711. An image 1713 is a result of applying a decoration pattern of the image 1708 to the image 1706. An image 1714 is a result of applying a decoration pattern of the image 1709 to the image 1707. A brightness contrast 1715 indicates the brightness contrast of an illumination pattern in the images 1713 and 1714. Since a decoration pattern is generated and applied to each of the respective characters of the images 1706 and 1707, the brightness contrast of illumination in the images 1713 and 1714 after the decoration pattern is applied become substantially the same value as indicated by the brightness contrast 1715.

As described above, according to the present embodiment, when a region to be processed includes a plurality of objects such as character objects, the region is divided into respective regions configuring an object, and the decoration pattern is generated in accordance with the size of each divided region. This makes it possible to reduce a difference in an impression of metallic texture between objects.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-126046, filed Jul. 30, 2021, which is hereby incorporated by reference herein in its entirety.

What is claimed is:

1. A method comprising:
setting a region in which decoration processing is to be applied on an image according to decoration data;
acquiring texture data representing a texture image of a predetermined size;
acquiring illumination data representing a brightness contrast of a region of a predetermined size;
processing the acquired texture data so as to accord with a size of the set region;
processing the acquired illumination data so as to accord with the size of the set region; and
generating the decoration data from the processed texture data and the processed illumination data, and applying the decoration data to the set region.

2. The method according to claim 1, wherein in the processing of the texture data, a frequency characteristic of the texture image is not changed.

3. The method according to claim 2, wherein in the processing of the texture data, clipping is performed on the texture image or tiling is performed using the texture image.

4. The method according to claim 3, wherein in the processing of the texture data, in a case where the size of the set region is larger than the predetermined size of the texture image, tiling is performed using the texture image so as to accord with the size of the set region.

5. The method according to claim 4, wherein in the processing of the texture data, after tiling using the texture image, clipping is performed on a texture image in which the tiling has been performed.

6. The method according to claim 3, wherein in the processing of the texture data, in a case where the size of the set region is smaller than the predetermined size of the texture image, clipping is performed on the texture image.

7. The method according to claim 1, wherein in the processing of the illumination data, in a case where the size of the set region is larger than the predetermined size of the region of the illumination data, enlargement of the region of the illumination data is performed.

8. The method according to claim 7, wherein in the processing of the illumination data, in a case where the size of the set region is larger than the predetermined size of the region of the illumination data and a change of the brightness contrast represented by the illumination data is smaller than a reference, enlargement of the region of the illumination data is performed.

9. The method according to claim 8, wherein in the processing of the illumination data, in a case where the size of the set region is larger than the predetermined size of the region of the illumination data and the change of the brightness contrast represented by the illumination data is larger than the reference, tiling using the illumination data is performed instead of enlargement of the region of the illumination data being performed.

10. The method according to claim 9, wherein in the processing of the illumination data, after tiling using the illumination data is performed, clipping is performed on a region of illumination data in which the tiling has been performed, so as to accord with the size of the set region.

11. The method according to claim 8, wherein in the processing of the illumination data, in a case where the size of the set region is larger than the predetermined size of the region of the illumination data and the change of the brightness contrast represented by the illumination data is larger than the reference, supplementation of a pixel in a periphery of the region of illumination data is performed instead of enlargement of the region of the illumination data being performed.

12. The method according to claim 1, further comprising: performing adjustment of a brightness contrast on the processed illumination data based on a skewness of a luminance histogram of the texture image.

13. The method according to claim 1, wherein in the acquiring of the illumination data, the illumination data is acquired based on the size of the set region.

14. The method according to claim 1, further comprising:
in a case where the set region includes a plurality of objects, extracting a plurality of regions from the set region, wherein
each of the extracted plurality of regions is processed as a set region.

15. The method according to claim 14, wherein in the extracting of the plurality of regions, extracting, as the plurality of regions, regions respectively corresponding to the plurality of objects.

16. The method according to claim 14, wherein the extracted regions include a plurality of objects.

17. The method according to claim 14, wherein an object included in the set region is a character.

18. The method according to claim 1, further comprising: causing a printing apparatus to print data to which the decoration data has been applied.

19. An image processing apparatus comprising:
a setting unit configured to set a region in which decoration processing is to be applied on an image according to decoration data;
a first acquisition unit configured to acquire texture data representing a texture image of a predetermined size;
a second acquisition unit configured to acquire illumination data representing a brightness contrast of a region of a predetermined size;
a first processing unit configured to process the texture data acquired by the first acquisition unit so as to accord with a size of the region set by the setting unit;
a second processing unit configured to process the illumination data acquired by the second acquisition unit so as to accord with the size of the region set by the setting unit; and
an application unit configured to generate the decoration data from the texture data processed by the first processing unit and the illumination data processed by the second processing unit, and apply the decoration data to the region set by the setting unit.

20. A non-transitory computer-readable storage medium storing a program configured to cause a computer to:
set a region in which decoration processing is to be applied on an image according to decoration data;
acquire texture data representing a texture image of a predetermined size;
acquire illumination data representing a brightness contrast of a region of a predetermined size;
process the acquired texture data so as to accord with a size of the set region;
process the acquired illumination data so as to accord with the size of the set region;
generate the decoration data from the processed texture data and the processed illumination data, and apply the decoration data to the set region.
